(19) United States
(12) Patent Application Publication
(10) Pub. No.: US 2023/0186913 A1
(43) Pub. Date: Jun. 15, 2023

(54) DEVICE FOR THE MONITORING OF SPEECH TO IMPROVE SPEECH EFFECTIVENESS

(71) Applicant: Jaclyn Patterson, Vancouver, WA (US)

(72) Inventor: Jaclyn Patterson, Vancouver, WA (US)

(21) Appl. No.: 17/962,438

(22) Filed: Oct. 7, 2022

Related U.S. Application Data
(60) Provisional application No. 63/253,742, filed on Oct. 8, 2021.

(51) Int. Cl. G10L 15/22; G10L 15/25; G06F 3/01

(52) U.S. Cl. CPC G10L 15/22; G10L 15/25; G06F 3/017; G10L 2015/225

(57) ABSTRACT

A real-time speech evaluation and feedback system has a computer system. A microphone is coupled to the computer system. A video capture device is coupled to the computer system. A biometric device is coupled to the computer system. Interactions are recorded onto the computer system using the microphone and video capture device. A first feature of the interaction is extracted based on data from the microphone and video capture device while recording the interaction. A metric is calculated based on the first feature. An alert is deployed in response to a change in the metric. The triggering of the metric change is recorded.

### CLAIM OF DOMESTIC PRIORITY

The present application claims the benefit of and priority to U.S. Provisional Application Ser. No. 62/253,762, filed Oct. 8, 2021, entitled “Device for the Monitoring of Speech to Improve Speech Effectiveness” which is hereby incorporated herein by reference, in its entirety for all that it teaches and for all purposes.

### FIELD OF THE INVENTION

The present invention relates in general to improvement in public speaking ability and, more particularly, to real-time analysis and feedback for public speaking, both in training and during live presentations.

### BACKGROUND OF THE INVENTION

Public speaking is a common activity today. It begins in grade school, when students answer questions and give reports in front of the class, and continues all the way through many professions, such as lawyers, politicians, teachers, store managers, and more. At public and private meetings across the globe, people stand before crowds to deliver committee reports, financial reports, or technical presentations; to answer questions, announce news, or otherwise report information to a crowd. FIG. 1 illustrates a speaker performing a presentation in front of audience members at a board meeting.

Public speaking is a challenging skill that almost everyone could improve upon, and which very few feel totally comfortable performing. Some people fear public speaking to the point of physical distress, nausea, and feelings of panic. A number of methods have been proposed to overcome fear of public speaking, or to improve public speaking skills. The challenges with prior art methods for public speaking practice mean that practice is time consuming and of limited value. Rehearsal in front of a mirror, or in front of a small group of friends and family, offers some benefit, but the feedback received by the presenter is subjective, and unlikely to include serious constructive advice.

A person can make a video or audio recording while practicing a speech, and then self-review the recording to determine where improvements could be made. However, that individual cannot provide professional guidance, and reviewing a recording takes significant time. When only a few specific points of the practice speech contain issues worth noting for improvement, and feedback is not generally instantaneous, or even quick, the value is minimal. A person may not review the recording until a significantly later time—or, if the person wants a skilled second party to review the tapes, even more time could pass before feedback is received.

The result is that many speakers will practice a speech once or twice prior to public speaking, but will not continue practicing to develop and perfect public speaking skills. Any benefit from practicing a speech once or twice is lost because the speaker does not continue the practice to reinforce public speaking skills.

In addition to practice, there is a lack of real-time feedback during live presentations that can make it difficult for a speaker to understand the quality of their performance and make adjustments throughout. These challenges with prior art methods for real-time public speaking evaluation mean that speakers cannot ensure a high-quality performance. The result is that speakers are left without the support during live presentations that they received during practice. They are left with only the facial expressions and reactions of the audience as a guide to their speech performance.

Current presentation and public speaking improvement solutions do not offer simulations and real-time feedback, limiting user engagement. Furthermore, current solutions lack sufficient mechanisms for practice, assessment, and reinforcement resulting in poor training continuity, suboptimal retention, and loss of skills. Current training solutions therefore produce poor returns on training investment.

### BRIEF DESCRIPTION OF THE DRAWINGS

FIG. 1 illustrates a person presenting at a board meeting;

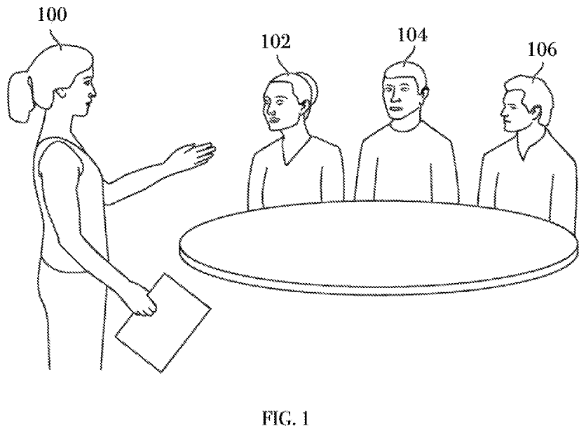

FIG. 2 illustrates a computer system to provide real-time feedback for a public speaking feedback system;

FIG. 3 illustrates an electronic communication network used by the computer system to communicate with a computer server;

FIG. 4 illustrates a cloud network;

FIG. 5 illustrates a computer application utilizing a plurality of software engines;

FIG. 6 illustrates a flow or process diagram of a method providing an alert to a user in response to a deviation from the expected state;

FIG. 7 illustrates physical and other presentation inputs to a speech analysis engine;

FIG. 8 illustrates a supervised machine learning classification algorithm;

FIG. 9 illustrates initial setup of the public speaking training system;

FIG. 10 illustrates an activity selection screen of the public speaking training system;

FIG. 11 illustrates a presentation being analyzed to provide real-time feedback and scores and ratings for the presentation;

FIG. 12 illustrates a person performing a live presentation with the public speaking real-time feedback system;

FIG. 13 illustrates a summary screen of the public speaking training system after completion of a presentation;

FIG. 14 shows examples of use cases for a public speaking real-time feedback system

### DETAILED DESCRIPTION OF THE DRAWINGS

The present invention is described in one or more embodiments in the following description with reference to the figures, in which like numerals represent the same or similar elements. While the invention is described in terms of the best mode for achieving objectives of the invention, those skilled in the art will appreciate that the disclosure is intended to cover alternatives, modifications, and equivalents as may be included within the spirit and scope of the invention as defined by the appended claims and claims equivalents as supported by the following disclosure and drawings.

A presentation feedback system including real-time feedback is presented. A user 100 uses the presentation feedback system to practice presentations and get real-time feedback during live presentations. The feedback system observes user 100 presenting via various inputs, including optical, audio, and biometric inputs, and is able to give real-time feedback during the presentation, summarize performance problems after the performance, and provide tips and tutorials for improvement. The feedback system provides a dynamic, goal-based, training and public speaking experience.

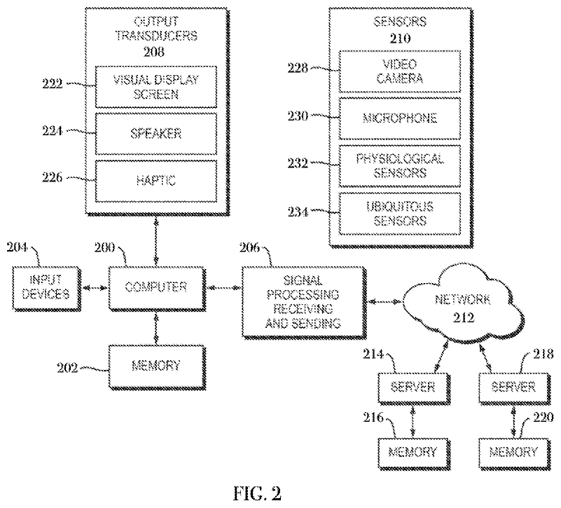

FIG. 2 is a block diagram of hardware used in an automated conversation coach. In the example shown in FIG. 2, sensors 210 gather data about a human user during a presentation session. The sensors 210 include a video camera (e.g., webcam) 228, microphone 230, physiological sensors 232, and ubiquitous sensors 234. Output transducers 208 provide humanly perceptible feedback to a human user. The output transducers 208 include a visual display screen 222, speaker 224 and haptic transducer 226. In other embodiments, the output transducers 208 include a stand-alone teleprompter, or a teleprompter that can be attached via a communication cable to the display screen 200.

A computer 200 receives sensor data from the sensors 210 and input data from input devices 204. The input devices 204 may include a mouse, keyboard, touch screen, haptic input device or other I/O (input/output) devices. The computer 200 may write data to, or read data from, an electronic memory 202. The computer 200 may be connected to a network (e.g., the Internet) 212 via apparatus for signal processing and for receiving and sending data 206. Through the network 212, the user's computer 200 may interface with servers (e.g., 214, 218) that control the feedback system and UI. The servers (e.g., 214, 218) may store data in, and retrieve data from, memory devices (e.g., one or more hard drives) 216, 220.

Program code for the training system is distributed via a portable mass storage medium, such as a compact disk (CD), digital versatile disk (DVD), or thumb drive. The program may also be downloaded over the internet or another network. Program code for the training system is initially stored in mass storage. The program code downloaded over the internet directly to mass storage, or the program code is installed from a CD or DVD onto mass storage. In some embodiments, the program code runs from the CD or DVD rather than being installed onto mass storage. In other embodiments, the program code comes preloaded on the machine.

Data from inputs 204 streams to the computer 200, which handles the data as instructed by the program code of the feedback system and applies analysis algorithms to the data from inputs 204 to extract presentation features, calculate scores and ratings, and generate other feedback to benefit user 200 which is distributed via the output transducers 208. In some embodiments, the computer 200 sends select streaming data from input peripherals 204 to other computers, such as a local server or cloud server for analysis.

The network 212 represents any hardware device of computer system 200 capable of communicating with other computer systems and servers. In one embodiment, the network 212 is reached via a wired or wireless Ethernet adapter. The network 212 represents a network cable or a wireless link to another computer system or to a local network router.

The display 222 shows a graphical user interface with contents controlled by executing the program code of the feedback software. While user 100 is giving a presentation to the display 222 shows feedback based upon the content of the presentation and how well the speech is delivered by user 100. Feedback to help user 100 develop and monitor presentation skills is presented visually on display 222 during the speech, and a summary including final performance ratings and tips is shown on the display after a presentation is complete. Display 222 may show user 100 giving the speech as a thumbnail while the user is presenting, and may also show the video of the speech after the presentation is complete for review by the user.

Display 222 is integrated into computer system 200 in some embodiments, such as when computer system 200 is a cell phone, tablet, virtual reality headset, or stand-alone teleprompter device. In other embodiments, display 222 is an external monitor or teleprompter connected to computer system 200 via a video cable.

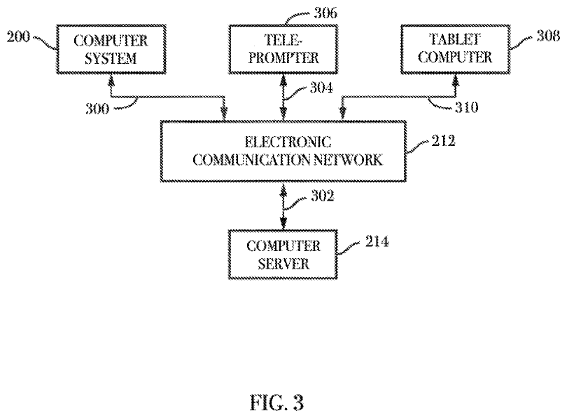

FIG. 3 illustrates an electronic communication network 212 that computer system 200 connects to via communication link 300. Electronic communication network 212 represents any digital network, such as the internet, a private wide-area network (WAN), a corporate network, or a home local area network (LAN). Electronic communication network 212 includes a plurality of network cables, switches, routers, modems, and other computer systems as necessary to route data traffic between computer system 200 and other computer systems connected to the electronic communication network.

Computer system 200 is located at a home, office, or other location accessible by user 100. Computer system 200 communicates with computer server 214 via electronic communication network 212. Data packets generated by computer system 200 are output through communication link 300. Electronic communication network 212 routes the data packets from the location of computer system 200 to the location of computer server 214. Finally, the packets travel over communication link 302 to computer server 214. Computer server 214 performs any processing necessary on the data, and returns a message to computer system 200 via a data packet transmitted through communication link 302, electronic communication network 212, and communication link 300. Computer server 214 also stores the data received from computer system 200 to a database or other storage in some embodiments.

Teleprompter 306 is connected to electronic communication network 52 via communication link 304, and tablet computer 308 is connected to the electronic communication network via communication link 310. Communication links 304 and 310 can be cellular telephone links, such as 5G, LTE, or WiMAX, in some embodiments. Cell phone 306 and tablet computer 308 are portable computer systems that allow user 100 to utilize the public speaking feedback system from any location with cellular telephone service or Wi-Fi.

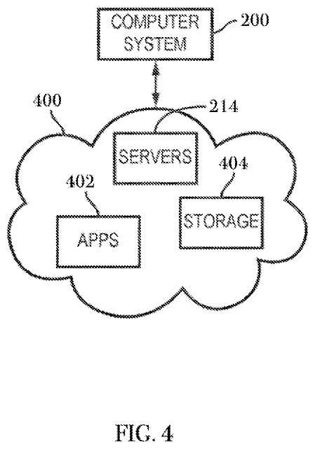

FIG. 4 illustrates cloud network 400. Cloud network 400 represents a system of servers 212, applications 402, and remote storage 404 that computer system 200 connects to and utilizes via communication link 300 and electronic communication network 212. Computer system 200 utilizes functionality provided by servers 214, applications 402 served by or running on servers 214 or other servers, and remote storage 404 located at servers 214 or in other locations. Servers 214, apps 402, and storage 404 are all used by user 100 connecting to a single uniform resource locator (URL), or using a single application on computer system 200, even though apps 402 and storage 404 may exist across a plurality of computer servers 214. Computer system 200 connects to the various computer resources of cloud network 400 transparently to user 100, necessary to perform the functionality of the public speaking feedback program.

Cloud 400 is used in some embodiments to serve the program code for the public speaking feedback program to computer system 200 for use by user 100 to practice a presentation or for real-time feedback during a live presentation. The training program exists as an application 402 in cloud 400 rather than on a mass storage device local to computer system 200. User 100 visits a website for the feedback program by entering a URL into a web browser running on computer system 200. Computer system 200 sends a message requesting the program code for the training software from a server 214. Server 214 sends the application 402 corresponding to the presentation feedback software back to computer system 200 via electronic communication network 212 and communication link 302. Computer system 200 executes the program code and displays visual elements of the application in the web browser being used by user 100.

In some embodiments, the program code for the public speaking feedback application is executed on server 214. Server 214 executes the application 402 requested by user 100, and simply transmits any output to computer system 200. Computer system 200 streams the physical input data representing a presentation by user 100, and any other data required for the feedback program, to servers 214 via network 212. Servers 212 stream back feedback to computer system 200.

Besides serving the presentation feedback program as an application 402, cloud 400 is also used to analyze the physical input data representing a presentation by user 100 in some embodiments. As user 100 gives a presentation to computer system 200, the computer system streams collected data to servers 214 for analysis. Servers 214 execute program code that analyzes the text of the presentation, as well as movement, eye contact, and other visual cues from video of the presentation, in addition to haptic and biometric cues to extract features, calculate metrics, and determine any feedback that should be given to user 100. Cloud 400 can be used to analyze the presentation of user 100 whether the training program exists as an application 402 on cloud 400, or if the program code is installed and executed locally to computer system 200. In other embodiments, the program code running on computer system 200 performs all the analysis of presentation data locally to the computer system without transmitting the presentation data to servers 214 on cloud 400.

A third use of cloud 400 is as remote storage and backup for presentation data captured by the presentation feedback program. Computer system 200 sends video, audio, and other data captured during a presentation by user 100 to servers 214 which store the data in cloud storage 404 for future use. In some embodiments, video, audio, and other input data from the entire presentation is stored in storage 404 after the presentation. In other embodiments, only the features, statistics, metrics, and other results calculated by computer system 200 or servers 214 based on the audio and video presentation data is stored in cloud storage 404. The presentation data in storage 404 is used by user 100 at future times to review progress within the feedback program, to recall presentation tips and feedback provided by the feedback program, or to review the real-time feedback provided during a live presentation.

Presentation data for a plurality of users can be aggregated within storage 404 for review by a manager or supervisor at a company implementing the training program across an entire employee base. Results for multiple users could also be reviewed by a professor at a university monitoring the progress of students. A manager logs into a program connected to cloud 400 to view aggregate presentation data for each employee participating in the presentation feedback program. The management program can be hosted on cloud 400 as an application 402. The management program accesses the presentation data in storage 404 and presents a dashboard to the manager. The dashboard shows each participating employee and the progress being made. The manager can review employee performance and assess how well employees are progressing important skill sets. In embodiments where user 100 is simply an individual, and not participating in a corporate training program, result data can be stored on mass storage locally to computer system 200, rather than on storage 404 of cloud 400.

The presentation training program can be run totally on computer system 200, or may be run completely on cloud 400 and simply be displayed on computer system 200 or any of the output transducers 208. Any subset of the above described cloud functionality may be used in any combination in the various embodiments. In one embodiment, the functionality of the feedback application is implemented completely on cloud 400, while in other embodiments the functionality runs completely on computer system 200. In some embodiments, the functionality is split between cloud 75 and computer system 200 in any combination.

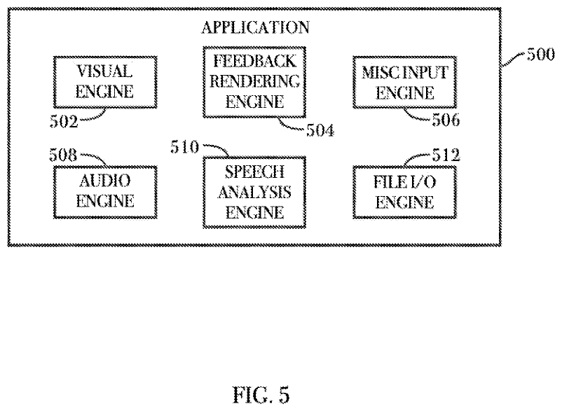

FIG. 5 illustrates the presentation feedback application 500 including a plurality of software engines providing the functionality of the application. Application 500 can be stored on mass storage as an installed program, stored in memory for execution, or stored in cloud 400 for remote access. A software engine can be a library, a software development kit, or other object that denotes a block of software functionality. Software developers can purchase engines pre-designed by third parties to provide certain functionality of application 500, and thereby prevent having to completely rewrite the program code for functionality that has already been adequately implemented by others. Engines can also be written from scratch for the unique functionality required to run application 500.

Application 500 includes a visual engine 502, feedback rendering engine 504, misc input engine 506, audio engine 508, speech analysis engine 510, and file input and output (I/O) engine 512. Other engines not illustrated are used in other embodiments to implement other functionality of application 500.

Visual engine 502 interfaces with the visual input hardware of computer system 200. Visual engine 502 allows application 500 to capture visual input from a video camera 228 connected to computer system 200 and display video output through the visual display screen 222 connected to computer system 200 without the programmer of application 500 having to understand each underlying operating system or hardware call.

Feedback rendering engine 504 is used to render feedback for the public speaking feedback program. The feedback is rendered by application 500 simply by making an application programming interface (API) call to the speech analysis engine 508.

Application 500 uses feedback rendering engine 504 to render the output for all output transducers 208. For example, for haptic feedback, application 500 uses feedback rendering engine 504 to generate haptic output to provide the user with important real-time feedback that will benefit their presentation.

Misc input engine 506 interfaces with the various other input hardwares of computer system 200. These miscellaneous inputs include haptic, biometric and other inputs. Misc input engine 506 allows application 500 to capture input from an input device 210 connected to computer system 200 and output through an associated output transducer 208 connected to computer system 200 without the programmer of application 500 having to understand each underlying operating system or hardware call.

Audio engine 508 interfaces with the sound hardware of computer system 200. Audio engine 508 allows application 500 to capture audio from a microphone connected to computer system 200 and play audio through speakers connected to computer system 200 without the programmer of application 500 having to understand each underlying operating system or hardware call.

Speech analysis engine 510 receives the audio, video, biometric, and other data captured during a presentation by user 100, extracts features of the presentation from the data, and generates metrics, statistics, feedback, tips, and other output to help the user develop and improve presentation skills, as well as evaluate real-time live presentations. Speech analysis engine 510 is critical functionality of presentation feedback application 500 and is programmed from scratch. However, in some embodiments, specific functionality required to observe and extract features from a presentation by user 100 is implemented using 3rd party software.

File I / 0 engine 512 allows application 500 to read and write data from mass storage, RAM, and storage 404 of cloud 400. File I/O engine 512 allows the programmer creating application 500 to utilize various types of storage, e.g., cloud storage, FTP servers, USB thumb drives, or hard drives, without having to understand each required command for each kind of storage.

Application 500 modularizes functionality into a plurality of software engines to simplify a programmer's task. Engines can be purchased from third parties where the functionality has already been created by others. For functionality new to application 500, engines are created from scratch. Each engine used includes an API that a programmer uses to control the functionality of the engine. An API is a plurality of logical functions and data structures that represent the functionality of an engine. Audio engine 504 includes an API function call to play a sound file through speakers of computer system 200, or to read any cached audio information from the microphone.

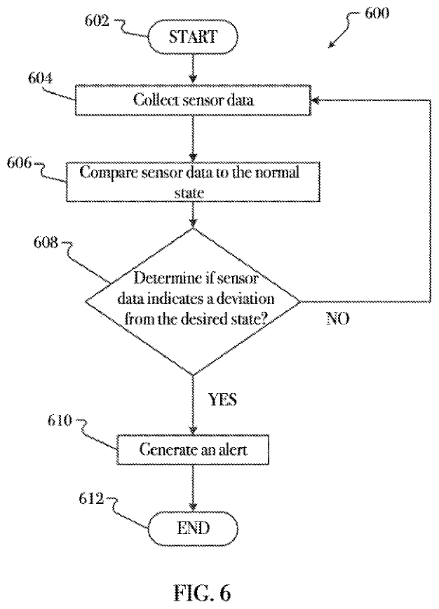

An embodiment of a method 600 of providing feedback to user 200 in response to a deviation from the expected speech is represented in FIG. 6. A general order for the steps of the method 600 is shown in FIG. 6. Generally, method 600 starts with a start operation 602 and ends with an end operation 612. The method 600 can include more or fewer steps or can arrange the order of the steps differently than those shown in FIG. 6. Additionally, although the operations of method 600 may be described or illustrated sequentially, many of the operations may in fact be performed in parallel or concurrently. The method 600 can be executed as a set of computer-executable instructions executed by a computer system 200 and encoded or stored on the computer system 200.

The feedback system 200 can collect data related to the user 100 from sensors 210 in step 604. The data may comprise information related to the user's voice or speech, or contain information from other sensory inputs such as video, haptic, and biometric. In one embodiment, the sensor data comprises one or more of intensity, pitch, pace, frequency, and loudness (for example, in decibels), speech cadence,spectral content, micro tremors and any other information related to the user's voice recorded by one or more sensors 210. The sensor data may also include biometric data, such as pulse rate, respiration rate, temperature, blood pressure, movement of the user, and information about the user's eyes from the sensors 210. In one embodiment, the sensor data includes data received from a device 228, 230, 232, 234 in communication with the feedback device 200.

The analysis engine 510 may then compare the collected sensor data to the expected state for high quality speech in step 606. In this manner, the analysis engine 510 can determine whether the sensor data is associated with a deviation from the expected state defined by a machine-learning based analysis of high-quality speeches. The analysis engine 510 may compare the volume of the user's voice to ambient noise levels to determine if the user's voice is too loud or too quiet. By evaluating one or more of the pitch, pace, frequency, volume, cadence, and micro tremors included in the user's voice, as well as other sensory inputs, the analysis engine 510 can determine if feedback should be provided to the user 100 to improve the quality of their speech.

If the sensor data does not indicate a deviation from the normal state of the user, method 600 may return NO to collecting new sensor data, in step 608. In this way, the sensor data is periodically or continually collected and analyzed by the analysis engine 510 to determine whether the sensor data is associated with a deviation from the desired state. If the sensor data does indicate a deviation from the desired state of the user's speech, method 600 proceeds YES to operation 610.

In operation 610 the computer system 200 triggers feedback to be provided to the user. The alert may include providing an alert to the user via the output transducers 208. The alert can be at least one of audible, visible, and haptic. In one embodiment, the alert is provided by the feedback device 222. Additionally, or alternatively, the alert is generated by a device 224 or 226. In one embodiment, a first alert is associated with the volume of the user's voice, a second alert is associated with an abnormal gesture made by the user, and a third alert is associated with an overly rapid cadence by the user. In one example, when the user's voice deviates from a normal state, such as when the user is speaking too loudly based on ambient noise levels collected by sensors 210, the computer system 200 may determine that feedback should be provided to the user in operation 610. The feedback may include one or more of a first visual signal, a first haptic signal, and a first audible signal. Similarly, if the user 100 is speaking too quietly, a second alert may be provided to the user in operation 610. Similarly, the alert may comprise a first vibration when the user's voice is too loud and a second vibration when the user's voice is too quiet. In another embodiment, the first vibration has a first pattern, a first intensity, and a first duration that is different from a second pattern, a second intensity, and a second duration of the second vibration.

Additionally, or alternatively, the alert provided in operation 610 may include providing a notification to another device. For example, if the computer system 200 determines the user 100 is experiencing an emotional state associated with anger, the alert of operation 610 may include notifying another person, such as a coworker or friend of the user 100, by contacting that person's device using network 212.

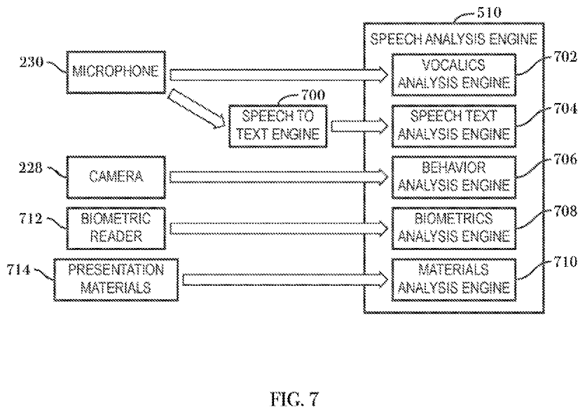

FIG. 7 illustrates speech analysis engine 510. Speech analysis engine 510 receives signals from the various input peripherals 210 of computer system 200 and analyzes the inputs to extract features of the presentation and generate metrics used by application 500 to observe and critique a presentation given by user 100. The inputs to speech analysis engine 510 include microphone 230, camera 228, biometric reader 712, and presentation materials 714. The audio from microphone 230 is routed through speech to text engine 700 to generate text of the words that user 100 is speaking. The text from speech to text engine 700 is routed as an additional input to speech analysis engine 510. Speech analysis engine 510 includes a vocalics analysis engine 702, a text analysis engine 704, a behavior analysis engine 706, a biometrics analysis engine 708, and a materials analysis engine 710.

Microphone 230 is electrically connected to a line-in or microphone audio jack of computer system 200. Microphone 230 converts analog audio signals in the environment, e.g., speech from user 100, to an analog electrical signal representative of the sounds. Audio hardware of computer system 200 converts the analog electrical signal to a series of digital values which are then fed into vocalics analysis engine 702 of speech analysis engine 510. In other embodiments, microphone 140 generates a digital signal that is input to computer system 200 via a Universal Serial Bus (USB) or other port.

In one embodiment, microphone 230 is a part of a headset worn by user 100. The headset includes both headphones for audio output by computer system 200 to user 100, and microphone 230 attached to the headphones. The head set allows for noise cancellation by computer system 200, and improves the audio quality for the presentation received by speech to text engine 700 and vocalics analysis engine 702.

Vocalics analysis engine 702 analyzes the sound generated by user 100, rather than the content of the words being spoken. By analyzing the sound from user 100, vocalics engine 702 identifies the pace at which the user is speaking, how the pitch, volume, and pace of the user's voice is changing, and the timing and length of pauses inserted by the user. Vocalics analysis engine 510 analyzes the rhythm, intonation, and intensity of the user's voice during a presentation. Vocalics analysis engine 702 provides an engagement score based on the amount of variability in select features of the voice of user 100. In one embodiment, the engagement score provided by vocalics analysis engine 702 is based on the pitch, pace, and volume with which user 100 speaks.

Speech-to-text engine 700 converts the audio signal of the voice of user 100 into text representative of the words being spoken by the user. The text from speech to text engine 700 is provided as an input to speech text analysis engine 704. Text analysis engine 704 analyzes the content of the presentation by user 100. Text analysis engine 704 performs natural language processing and determines linguistic complexity of the speech, analyzes word choice, and marks the use of verbal distractors.

Verbal distractors are sounds or words such as “uhhh,” “ummm,” “basically,” and “like” which a speaker commonly uses to fill gaps of silence or while trying to remember what to say next. Linguistic complexity is an overall rating of the vocabulary being employed by user 100. Text analysis engine 704 rates the linguistic complexity by education level. For example, user 100 may be rated as using words at a middle school level, a university level, or at a professional level. Complexity is determined by performing syntactic analysis utilizing language models.

Word choice analysis looks more specifically at the individual words and phrases used by user 100. Text analysis engine 704 flags a word that appears to be used incorrectly by user 100, and also flags weak language when another more effective word or phrase could be used. If user 100 overuses a specific word or phrase, text analysis engine 704 may flag uses of the phrase to encourage the user to mix in a larger variety of language. If user 100 knows she has a specific problem with certain words or phrases she doesn't want to say, the user can configure application 500 so that speech text analysis engine 704 flags uses of the undesirable words. Flagged words and phrases are features output by text analysis engine 704.

Speech text analysis engine 704 is programmed with specific words and phrases commonly used in specific domains of speech, e.g., in the tech sector or among financial institutions. Speech text analysis engine 704 generates a metric identifying how well user 100 is utilizing the language of a specific domain where the user will be speaking, and suggests word replacements to use language more fitting for the domain. Text analysis engine 704 uses linguistic analysis to generate metrics for clarity and conciseness of speech, sentence structure, sentence length, grammar, audience relatability, professionalism, and competency. Speech text analysis engine 704 extracts other features from the speech text as user 100 presents. Speech text analysis engine 704 identifies a feature when user 100 begins a sentence, ends a sentence, begins a narrative, ends a narrative, etc.

Advanced analysis of the structure of a presentation is performed by text analysis engine 704. Text analysis engine 704 analyzes the beginning and ending of a speech to create a metric rating whether user 100 properly opened and closed the speech, whether the main idea of the speech has been clearly communicated, and whether the body of the speech is structured in a coherent manner. The text of the speech is analyzed to identify metaphors and contrasting language, and generate a metric of proper metaphor use. Metaphors are also output as features. Storytelling or anecdotal elements in the text of the presentation are identified and output as features. A metric to gauge the amount and effectiveness of storytelling and anecdotes being used is also generated.

Text analysis engine 704 is able to identify emotional versus analytical content of the presentation and generates a metric of the proportion of analytical and emotional content. A discourse clarity metric is generated that incorporates computational discourse analysis based on rhetorical structure theory and coherence models. The discourse clarity metric models the flow of concepts discussed in the presentation to identify whether an audience member is likely to be able to follow the ideas and logic of the presentation, and whether the sentences have a syntactic structure that is too complex for the intended audience of the presentation.

Features and metrics output from vocalics analysis engine 702 are combined with results from speech text analysis engine 704 to generate a perception metric. The perception metric rates or identifies how user 100 is being perceived by a crowd. User 100 may be perceived by the crowd as enthusiastic, confident, charismatic, emotional, convincing, positive, competent, etc. The perception metric may include a numerical rating for each possible perception category, e.g., a separate numerical indicator of how enthusiastic, how confident, how emotional, how charismatic, and how convincing user 100 is in their presentation.

Behavior analysis engine 706 receives a video stream of user 100 performing a presentation. The video feed is received by application 500 from camera 228 and routed to behavior analysis engine 706. Behavior analysis engine 706 looks at the behavior of user 100 while presenting the speech. Body movement, posture, gestures, facial expression, and eye contact are all analyzed. Behavior analysis engine 706 looks at body movement, gestures, and posture of user 100 to flag or output a feature if the user is fidgeting her hands, rocking back and forth, or exhibiting other undesirable body movements while presenting. Behavior analysis engine 706 observes the body of user 100 to ensure that the user is properly facing toward the audience. The body movement of user 100 is also analyzed for proper use of hand gestures that match or complement the text of the speech by tying together the outputs of speech text analysis engine 704 and behavior analysis engine 706. Features are output by speech analysis engine 510 corresponding to hand gestures by user 100. Body movement of user 100 is analyzed to ensure adequate movement and gestures. Behavior analysis engine 706 generates a feature for body movement, and flags if the user is too rigid in their appearance or mechanical in their movements. In one embodiment, a third party software application, e.g., Visage, or a hardware device, e.g., Tobii, is used to implement eye tracking. Third party software is also used to track body movement in some embodiments.

Other peripheral devices may supplement the information received from camera 228. In one embodiment, user 100 wears wrist-bands or another peripheral that monitors the position of the user's hands relative to their body and reports hand movements to behavior analysis engine 706. Other motion capture methods are used in other embodiments. In some embodiments, two cameras 228 are used. Parallax between the two cameras 228 helps give behavior analysis engine a depth of view and better gauge the distance of each body part of user 100 from the cameras.

The facial expression of user 100 is monitored to generate a feature when the user does not maintain a desirable facial expression. User 100 should maintain a happy and positive facial expression in most situations, but other facial expressions may be desirable when discussing a negative opinion or relating a harrowing anecdote. Behavior analysis engine 706 also helps monitor for nervous tics or other behavioral anomalies of user 100, such as randomly sticking out the tongue for no reason or blinking in an unsightly manner, by outputting those presentation features to application 500.

Eye contact is monitored to ensure that user 100 sufficiently maintains the important connection with the audience that eye contact provides. The video of user 100 presenting is captured by camera 228, and behavior analysis engine 706 analyzes the image to determine where the user is looking. Behavior analysis engine 706 determines how well user 100 is maintaining eye contact with the crowd, and how well the user is moving eye contact across different areas of the crowd. The direction or location that user 100 is looking is output and stored as a presentation feature.

Behavior analysis engine 706 creates a log of a presentation, identifying when user 100 is looking at the crowd, and when the user is looking elsewhere. Behavior analysis engine 706 outputs a feature when the eye contact state of user 100 changes, e.g., from looking down at notes to looking at the crowd. Eye contact features of user 100 are compared against pre-specified metric thresholds to generate an overall eye contact score. Statistics are available which identify what percentage of the time the user is looking at the crowd. The eye contact score takes into consideration if user 100 looked at each person or section of the room for approximately the same amount of time. If user 100 exhibits a particular problem, such as staring down at their feet for long periods of time, presentation feedback application 500 uses the information from behavior analysis engine 706 to identify the problem and provide tips and offer video lessons to the user to address the problem.

In one embodiment, user 100 uploads presentation materials, such as text of a speech, presentation slides, or notecards to be used for reference during the presentation. User 100 toggles may view the presentation materials on the same screen as the feedback. The amount of time user 100 spends looking at presentation materials is considered by application 500 to be time not in eye contact with the audience.

In some embodiments, a separate camera 228 is zoomed in to capture a high quality image of the face of user 100. In embodiments with a separate camera 228 for facial recognition, a first camera 228 is zoomed back to capture the entire body of user 100 and observe general body movement while a second camera 228 is zoomed in on the face of user 100 to capture higher quality images for better facial recognition and eye contact analysis. Object tracking can be used to keep the second camera trained on the face of user 100 if the user moves around while presenting. In other embodiments, two cameras are zoomed out to capture user 100 as a whole, in order to get a field of depth, and a third camera is trained on the face of the user.

Biometric reader 712 reads biometrics of user 100 and transmits a data feed representing the biometrics to biometrics analysis engine 708. Biometrics analyzed by biometrics analysis engine 708 include blood pressure, heart rate, sweat volume, temperature, breathing rate, etc. Biometric devices 712 are located on the body of user 100 to directly detect biometrics, or are disposed at a distance and remotely detect biometrics. In one embodiment, biometric reader 712 is an activity tracker that user 100 wears as a bracelet, watch, necklace, or piece of clothing, that connects to computer system 200 via Bluetooth or Wi-Fi. The activity tracker detects heartbeat and other biometrics of user 100 and transmits the data to computer system 200. In some embodiments, biometric reader 712 provides information as to movements of user 100 which are routed to behavior analysis engine 706 to help the behavior analysis engine analyze body movements of the user.

User 100 inputs their presentation materials 714, such as overhead slides or handouts, to application 500 for analysis. Materials analysis engine 710 looks at the materials 714 to provide metrics related to how well user 100 is using slides. Metrics include a rating for the number of points on each slide, the amount of time spent on each point, slide design, usage of text versus images, and the type and organization of content. Presentation features extracted from presentation materials 714 include when user 100 advances to the next slide, or when a new bullet point on the same slide is reached.

Each analysis engine 702-710 of speech analysis engine 510 outputs features as user 100 performs a presentation. When a presentation feature is detected, such as a pause in speaking, usage of a certain word, or a break in eye contact, a result signal is generated by a respective analysis engine 702-710. Application 500 captures the features and performs further analysis to determine overall scores and ratings of the performance, generate tips and suggestions, and provide real-time feedback. Application 500 captures the results and outputs of analysis engines 702-710, and analyzes the results based on predetermined metrics and thresholds.

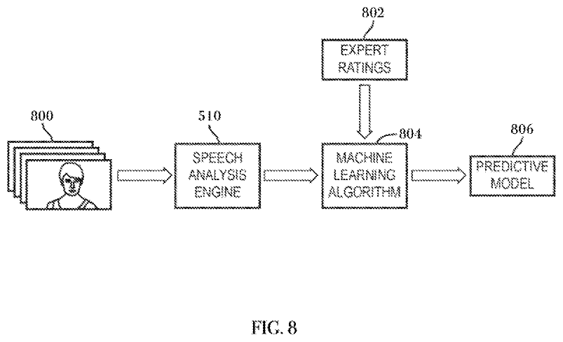

To interpret the features and metrics from speech analysis engine 510, a supervised machine classification algorithm is used, as illustrated in FIG. 8. Pre-recorded speeches 800 are input into speech analysis engine 510 to extract features and generate metrics for each of the pre-recorded speeches. The features and metrics from speech analysis engine 510, as well as ratings 802 provided by experts who have observed the speeches 800, are input into machine learning algorithm 804. Machine learning algorithm 804 is used to generate a predictive model 806. Predictive model 806 defines correlations between features and metrics from speech analysis engine 510 and ratings 802 of speeches 800 provided by public speaking experts.

Thousands of speeches 800 are input into speech analysis engine 510 to form the basis of predictive model 806. A wide variety of speeches, both good and bad, are input into the machine learning algorithm. Each speech is input into speech analysis engine 510 to generate the same features and metrics that will be generated when user 100 uses presentation feedback application 500. In addition, experts are employed to observe speeches 800 and provide ratings 802 based on the experts' individual opinions. In one embodiment, six public speaking experts rate each individual speech 800 to provide the expert ratings 802. In another embodiment, historic speeches 800 are used and historic evaluators are used to provide expert ratings 802.

Machine learning algorithm 804 receives the features and metrics from speech analysis engine 510, as well as the expert ratings 802, for each speech 800. Machine learning algorithm 804 compares the key features and metrics of each speech 800 to the ratings 802 for each speech, and outputs predictive model 806. Predictive model 806 includes rating scales for individual metric parameters and features used by application 500 to provide ratings to a presentation subsequently given by user 100. Predictive model 806 defines what features make a great speech great, and what features occur that result in a poor expert rating.

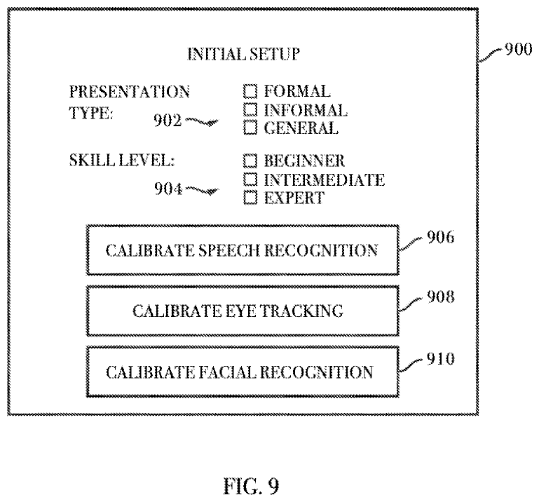

Presentations of user 100 are compared against predictive model 806 to provide tips and feedback. Prior to doing a presentation for analysis by application 500, user 100 performs an initial setup and calibration as shown in FIG. 9. FIG. 9 shows computer window or screen 222 with setup and calibration options 900-910.

Presentation type option 902 allows user 100 to enter a presentation type. An accurate presentation type setting helps speech analysis engine 510 interpret data from microphone 230, particularly the speech to text engine 700. Skill level option 904 tells application 500 an approximate starting level for the presentation skills of user 100. Setting skill level option 904 accurately helps application 500 present adjust thresholds for feedback. A beginner will have a higher threshold that must be reached before triggering an alert. An expert speaker will get feedback for smaller deviations.

Options 906-910 take user 100 to other screens where calibration occurs. Calibrate speech recognition option 906 takes user 100 to a screen that walks the user through a calibration process to learn the voice and speaking mannerisms of the user. User 100 is prompted to speak certain words, phrases, and sentences. The calibration process analyzes how user 100 speaks, and uses the data to interpret subsequent presentations using speech-to-text engine 700. Proper calibration helps application 500 generate an accurate textual representation of a presentation by user 100, which improves analysis accuracy of the content of the presentation.

Calibrate eye tracking 908 takes user 100 to a screen where application 500 is calibrated to better recognize where exactly the user is looking. User 100 is asked to move to various locations in the room, and look at directions dictated by application 500. Application 500 analyzes the face of user 100 from various angles and with eyes looking in various directions, and saves a model of the user's face for use in determining where the user is looking during a presentation. In one embodiment, the eye tracking calibration routine displays a dot that moves around display 222 while the eye calibration routine accesses video camera 228 to observe the eye movement and position of user 100 following the dot.

Calibrate facial recognition 910 is used to learn the features of the face of user 100. Photos of the face of user 100 are taken with webcam 228 from various angles, and the user is also prompted to make various facial expressions for analysis. User 100 may also be asked to confirm the exact location of facial features on a picture of her face. For instance, user 100 may be asked to touch the tip of their nose and the corners of their mouth on a touchscreen to confirm the facial recognition analysis. Facial recognition calibration helps speech analysis engine 510 accurately determine the emotions being expressed by user 100 while presenting. In one embodiment, facial recognition of presentation training application 500 is fully automatic, and no calibration is required to track mouth, chin, eyes, and other facial features. In other embodiments, calibration is not required, but may be used for enhanced precision.

In one embodiment, after setup and calibration is completed using page 900, application 500 uploads the configuration data to storage 404 of cloud 400. Uploading configuration data to cloud storage 404 allows user 100 to log into other computer systems and have all the calibration data imported for accurate analysis. User 100 can configure application 500 on a home personal computer, and then perform a live presentation in a conference room using a stand-alone teleprompter. The teleprompter is automatically set up and calibrated to the user's voice and face by downloading configuration data from cloud storage 404. In some embodiments, a portion of the calibration is required to be performed again if a new type of device is used, or when a different size of screen is used.

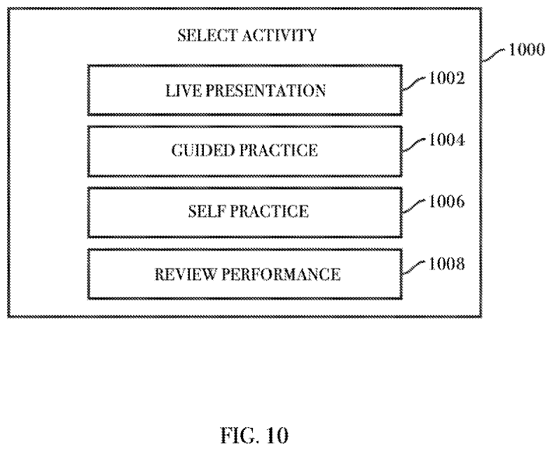

FIG. 10 shows a screen 1000 used by user 100 to begin a presentation feedback session using application 500. User 100 can launch the live presentation mode using option 1002, guided practice with option 1004, self-practice with option 1006, or review the analysis of past performances with option 1008.

Clicking or touching live presentation button 1002 takes user 100 to the presentation screen. Live presentation mode allows user 100 to perform any speech on any topic that the user needs to present. In one embodiment, after pressing live presentation button 1002, user 100 is asked to enter information about the presentation. Entering information such as desired length of presentation, topic of presentation, and technical expertise of crowd, helps application 500 perform analysis tailored to the particular type of presentation user 100 will be giving, and the type of audience user 100 will be speaking in front of. Application 500 can make sure that user 100 uses technical language appropriate for the technical level of the audience, and uses proper technical terms for the field of expertise.

The screen 222 displays the real-time feedback from the presentation. In some embodiments, the application will allow user 100 to upload presentation materials 714. In this case, the screen 222 may display the contents of the presentation behind the real-time feedback.

Following the presentation, the user 100 is presented with a screen providing the option of saving the recording or saving the recording with the real-time feedback. Privacy concerns may necessitate that the user 100 does not store the contents of the presentation.

User 100 does guided practice by clicking or touching button 1004. In guided practice, application 500 generates a hypothetical scenario for user 100 to practice a presentation. Application 500 gives user 100 a sample topic to speak on, or gives prompts for the user to answer. User 100 responds to the prompts, or speaks on the given topic for the allowed amount of time, and then application 500 rates the presentation and gives feedback.

Self-practice is performed by clicking or pressing self-practice button 1006. Self-practice allows user 100 to practice any speech on any topic that the user needs to present. In one embodiment, after pressing self-practice button 1006, user 100 is asked to enter information about the presentation. Entering information such as desired length of presentation, topic of presentation, and technical expertise of crowd, helps application 500 perform analysis tailored to the particular type of presentation user 100 will be giving, and the type of audience user 100 will be speaking in front of. Application 500 can make sure that user 100 uses technical language appropriate for the technical level of the audience, and uses proper technical terms for the field of expertise.

Review performance button 1008 allows user 100 to review each past practice performance to see what went right and what went wrong, review tips and feedback, or watch a performance as a whole. Both guided practice and self-practice can be reviewed. In addition to analysis and recordings of each past presentation user 100 has completed, application 500 presents summaries of performance trends over time. If user 100 has been steadily improving certain skills while other skills have stayed steady or worsened, the user will be able to see those trends under review performance button 1008.

The review performance screen 1008 will also allow users to share the results of their performance with other individuals or export to other formats. In some embodiments, the user is able to share their results to their employer or professor.

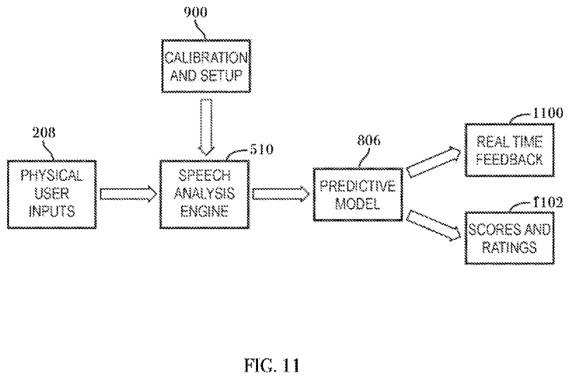

User 100 selects a presentation mode from screen 222, and then begins doing a live or practice presentation. FIG. 11 illustrates the process of application 500 analyzing a presentation by user 100. Physical user inputs 210 from input peripherals 228, 230, 712, 714, etc. are provided to speech analysis engine 510. Speech analysis engine 510 interprets physical user inputs 210 with the aid of the calibration and setup 900 that the user previously performed. Speech analysis engine 510 outputs identified features, calculated metrics, and other information that application 500 interprets through predictive model 806 to generate real-time feedback 1100 and scores and ratings 1102.

Physical user inputs 208 include microphone 230, camera 230, and biometric reader 712. User 100 also provides any presentation materials 714 being used if available. Speech analysis engine 510 receives the physical data generated by user 100 giving a presentation, and analyzes the content of the speech as well as the way the speech is being performed.

Calibration 900 helps speech analysis engine 510 analyze physical inputs 208 because the speech analysis engine becomes aware of certain idiosyncrasies in the way user 100 pronounces certain words, or the way the user smiles or expresses other emotions through facial expressions.

Speech analysis engine 510 extracts features and generates metrics in real-time as user 100 performs a presentation. The features and metrics are all optionally recorded for future analysis, and are routed to predictive model 806 for comparison against various thresholds contained within the predictive model. Based on how the presentation by user 100 compares to the speeches 800 that were expertly rated, application 500 generates real-time feedback during the presentation and scores and ratings for presentation after the presentation is complete.

Real-time feedback 1100 comes in the form of alerts and notifications. Application 500 provides optional audible, haptic, and on-screen alerts and status updates. Application 500 may display a graph of certain metrics over time that user 100 wants to keep an eye on during the presentation. An audible ding may be used every time user 100 uses a verbal distractor to train the user not to use distractors. A wearable may vibrate when user 100 has five minutes left in their allotted presentation time. Real-time feedback is configurable, and application 500 includes an option to completely disable real-time feedback 1100. User 100 presents uninterrupted and reviews all feedback after the presentation.

Scores and ratings 1102 are provided by application 500 when user 100 completes a presentation. Scores and ratings 1102 reflect the features and metrics of an entire presentation and may be based on peaks, averages, or ranges of metric values. Multiple scores are provided which are each based on a different combination of the metrics and features generated by speech analysis engine 510. In one embodiment, one overall score is presented, which combines all of the presentation attributes.

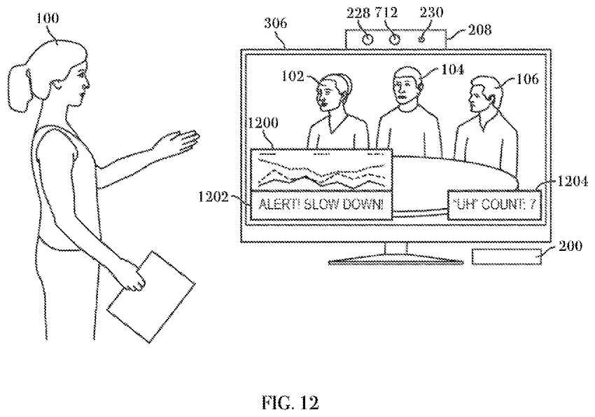

FIG. 12 illustrates user 100 giving a live presentation using application 500. In the embodiment of FIG. 12, a large, transparent teleprompter screen is used for the presentation. In other embodiments, other types of screens, such as projectors, phones, tablets, or computer monitors, are used.

In FIG. 12, a physical input device or sensor array 208 is mounted over teleprompter 306. Sensor array 208 includes microphone 230, camera 228, and biometric reader 712. In this embodiment, a computer 200 is set adjacent to teleprompter 306 to run application 500. In another embodiment, the teleprompter is a stand-alone device that is capable of running application 500. Microphone 230 receives sound waves from user 100 speaking during the presentation and converts the sound waves to an electrical signal. Microphone 230 is connected to computer 200 so that application 100 is able to receive input from the microphone. In some embodiments, an analog signal is generated by microphone 208 and converted to a digital signal by sound hardware of computer 200. In other embodiments, microphone 140 includes a built-in analog-to-digital converter and transmits a digital signal to computer 200.

Application 500 displays a feature or metric graph 1200 while user 100 is presenting. User 100 may configure metric graph 1200 to display metrics that the user is having trouble with or wants to practice. In other embodiments, application 500 displays any metric or feature that the application determines is of importance to user 100 at a particular moment. The metric or feature graph is rendered to change over time as the presentation by user 100 progresses. Values for the features and metrics are recalculated periodically and graph 1200 is updated to show how the values change. The metric graph 1200 may grow to the right as time passes, zoom out over time to stay the same size but still show a graph of the entire presentation, or only show the most recent period of time, e.g., the last thirty seconds of the presentation.

Alert or notification 1202 indicates when a metric is outside of a threshold goal. In FIG. 12, user 100 is going faster than a goal set by application 500 for the user. Application 500 uses notification 1202 to alert user 100 to pay attention to the pace of the presentation and slow down a bit to meet the goal. Other notifications are possible for any reason that application 500 may find use in communicating with user 100 during a presentation. Notifications 1202 are used to alert user 100 when time for the presentation is running out, when the user is moving around too much, or when the user needs to smile more. This information may be displayed textually. In other embodiments, the information may be portrayed to the user in other ways including but not limited to flashing lights or changing colors. For example, the bottom left corner of the screen may turn red if the user 100 is talking too fast, blue if the user is talking too slow, or green if the user is talking at an appropriate pace.

Counter 1204 is used to keep user 100 notified of the number of verbal distractors being used. User 100 may configure application 500 to show the distractor counter because the user knows a problem exists. Application 500 may also automatically show distractor counter 1204 if too many distractors are used. Counter 1204 may be used to show the total of all distractors used, or one particular distractor that user 100 uses excessively. Other counters are used in other embodiments. In one embodiment,a running total of the number of anecdotes is shown, or a timer showing elapsed or remaining time is displayed. This information may be displayed textually. In other embodiments, the information may be portrayed to the user in other ways including but not limited to flashing lights or changing colors. For example, if some threshold is reached, the counter may turn red.

In one embodiment, no display 306 is used while presenting. User 100 wears a headset with headphones and microphone 230 while presenting. Feedback application 500 receives and analyzes an audio signal of the presentation from microphone 140 without presenting real-time feedback using display 306.

In another embodiment, no display 306 is used while presenting. User 100 wears a wearable with haptic feedback, microphone 230, and biometric sensor 712 while presenting. Feedback application 500 receives and analyzes an audio signal of the presentation from microphone 230 as well as biometric input from the biometric sensor 713 and presents real-time haptic feedback as vibrations from the wearable.

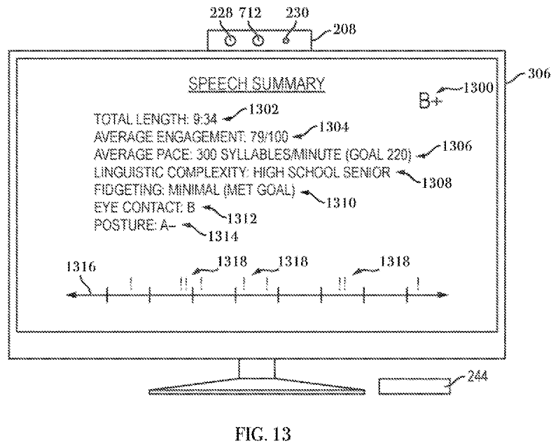

FIG. 13 illustrates a summary page that is displayed after user 100 completes a presentation. Application 500 gives the presentation an overall score 1300 in a letter grade or numerical form, and provides additional metrics, statistics, and scores. Application 500 reports total presentation time 1302, and can also notify user 100 how the total time of the presentation compared to a goal set by the user or by the application. Average engagement 1304 is presented as a total out of 100, but may also be a letter grade or other score. Average pace 1306 is displayed, and is compared to a goal that user 100 is trying to meet. The level of linguistic complexity used is displayed at 1308. The level of fidgeting during the presentation is displayed at 1310, because user 100 has displayed excessive fidgeting in the past. In the presentation just completed in FIG. 13, user 100 has met the goal of reducing fidgeting to a minimum. Eye contact has been graded a B by application 500, and is displayed at 1312. The posture of user 100 has been graded an A-, and is displayed at 1314.

Application 500 shows user 100 a timeline 1316 of the presentation. Timeline 1316 represents the entire presentation from beginning to end, and includes periodic vertical time markers to help orient user 10. Points of interest 1318 are displayed on the timeline as exclamation points, stars, or other symbols, and show the user where good or bad events happened during the presentation. In one embodiment, a first symbol is used to mark where the user performed especially well, and a different symbol is used to mark where the user did something that needs correction. In another embodiment, the timeline instead is a visual representation of the presentation materials 714 uploaded by the user 100.

User 100 clicks or touches one of the points of interest 1318 to pull up a screen with additional information. A popup tells user 100 what went right or what went wrong at that point of the presentation. A video window allows user 100 to view their presentation beginning right before the point where something of interest occurred. User 100 clicks through all of the points of interest 1318 to see each aspect of the presentation that application 500 determined needs attention, and continues practicing to get better at public speaking.

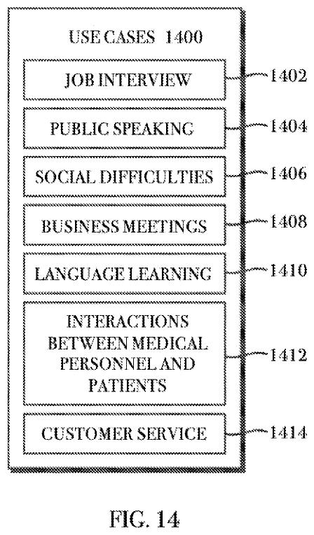

FIG. 14 shows examples of use cases 1400 for a public speaking feedback system. In exemplary implementations of this invention, a public speaking feedback system provides feedback to a human user, to improve the user's skills. For example, a public speaking feedback system may be used to help a user improve their skill in one or more of the following scenarios: job interviews 1402, public speaking 1404, social difficulties (e.g., poor social skills or stressful social situations) 1406, business meetings 1408, language learning 1410, interactions between medical personnel and patients 1412, or customer service 1414.

For example, a user may wear a wearable into a business meeting 1408 or a job interview 1402 to get feedback on their speech patterns and biometrics without the other individuals being aware. Alternatively, for a politician performing a speech, they may use the stand-alone teleprompter to get full audio, visual, biometric, and haptic analysis on their performance and dynamically improve their presentation using the real-time feedback.

What is claimed is :

1. A method of speech evaluation and feedback, comprising:
providing a speech analysis engine;
using the speech analysis engine to extract a plurality of features from a plurality of pre-recorded speeches;
providing manual ratings from public speaking experts for an overall quality of each of the plurality of pre-recorded speeches;
using a machine learning algorithm to compare the manual ratings of the pre-recorded speeches to the plurality of features extracted from the pre-recorded speeches, wherein the machine learning algorithm generates a predictive model defining correlations between the plurality of features and the manual ratings, and wherein the predictive model includes a plurality of rating scales with thresholds for the plurality of features, wherein a first rating scale for a first feature of the plurality of features includes a plurality of thresholds for rating the first feature and a first threshold of the plurality of thresholds is above a minimum and below a maximum of the first rating scale;
providing a computer system including a display monitor, a microphone, and a video capture device;
recording a presentation by the user onto the computer system using the microphone and the video capture device;
extracting the plurality of features from the presentation using the computer system;
analyzing the presentation by comparing the plurality of features extracted from the presentation against the thresholds of the rating scales of the predictive model; and
rendering feedback via an output transducer using the computer system in accordance with the environment configuration in response to at least one of the plurality of features.

2. The method of claim 1, further including:
providing a biometric device coupled to the computer system; and
extracting a second feature of the presentation based on data from the biometric device.

3. The method of claim 1, further including :
recording presentations for a plurality of users within an organization; and
presenting a dashboard that lists the plurality of users and a summary of activity of the plurality of users.

4. The method of claim 1, wherein the presentation configuration includes a type of presentation, and wherein the type of presentation is selectable from a list comprising informative, persuasive, and technical.

5. The method of claim 1, further including providing a second interface prior to recording the presentation, wherein the second interface allows the user to select which features of the presentation should be tracked.

6. The method of claim 1, wherein the plurality of features includes a body movement and a facial expression of the user.

7. A method of public speaking feedback, comprising:
using a speech analysis engine to extract a plurality of features from a plurality of prerecorded speeches;
providing manual ratings from public speaking experts for an overall quality of each of the plurality of prerecorded speeches;
using a machine learning algorithm to generate a predictive model defining correlations between the plurality of features and the manual ratings, wherein the predictive model includes a plurality of rating scales for the plurality of features, and wherein a first rating scale for a first feature of the plurality of features includes a plurality of thresholds for rating the first feature and a first threshold of the plurality of thresholds is above a minimum and below a maximum of the rating scale;
receiving a presentation configuration from a user;
receiving a presentation by the user after generating the predictive model;
extracting the first feature from the presentation; and
analyzing the presentation by comparing the first feature against the plurality of thresholds on the first rating scale of the predictive model

8. The method of claim 7, further including:
receiving a presentation material for the presentation;
providing a button to toggle between displaying the feedback only and simultaneously displaying the presentation material; and
recording an amount of time that the presentation material is displayed.

9. The method of claim 7, wherein the first feature relates to proper use of hand gestures that match or complement the text of the speech.

10. The method of claim 7, further including displaying an interface allowing the user to select a mode of operation for receiving the presentation, wherein the mode of operation is selectable from a list including the options of a live presentation, guided practice, and self-practice.

11. A method of speech training, comprising:
providing a predictive model including a plurality of rating scales for a plurality of presentation features, wherein a first rating scale for a first feature of the plurality of presentation features includes a plurality of thresholds for rating the first feature;
receiving a presentation by a user;
extracting the first feature from the presentation;
analyzing the presentation by comparing the first feature against the plurality of thresholds on the first rating scale of the predictive model; and
providing feedback as a result of analyzing the presentation.

12. The method of claim 11, further including receiving a configuration of a type of presentation, wherein the type of presentation is selectable from a list comprising formal, informal, and general.

13. The method of claim 12, further including analyzing the presentation based on the type of the presentation.

14. The method of claim 11, wherein the first feature includes usage of smiling.

15. The method of claim 11, further includes receiving a presentation material from the user, wherein the first feature includes usage of the presentation material.

16. A method of public speaking feedback, comprising:
providing a predictive model including a plurality of rating scales for a plurality of presentation features, wherein a first rating scale for a first feature of the plurality of presentation features includes a plurality of thresholds for rating the first feature;
receiving a presentation by a user;
extracting the first feature from the presentation; and
analyzing the presentation by comparing the first feature against the plurality of thresholds on the first rating scale of the predictive model.

17. The method of claim 16, further including:
receiving presentations for a plurality of users within an organization, and presenting a dashboard that lists the plurality of users and a summary of activity of the plurality of users.

18. The method of claim 16, wherein the first feature relates to body movements and gestures of the user.

19. The method of claim 16, wherein the first feature relates to facial expressions of the user.

20. The method of claim 16, wherein the first feature relates to biometric outputs of the user.
